(19) United States
(12) Patent Application Publication
(10) Pub. No.: US 2026/0347249 A1
(43) Pub. Date: Nov. 5, 2026

(54) NEEDLE FELT AND USE OF A FATTY ACID AMIDE AMINE IN THE PRODUCTION OF A NEEDLE FELT

(71) Applicant: SAINT-GOBAIN ISOVER, Courbevoie (FR)

(72) Inventors: Christian STRAßNIG, Ludwigshafen (DE); Thorsten ENGLMANN, Ludwigshafen (DE); Romain LECOMTE, Ludwigshafen (DE); Timo REINHEIMER, Ludwigshafen (DE)

(73) Assignee: SAINT-GOBAIN ISOVER, Courbevoie (FR)

(21) Appl. No.: 19/120,695

(22) PCT Filed: Oct. 6, 2023
(86) PCT No.: PCT/EP2023/077751

§ 371 Date: Apr. 11, 2025

(30) Foreign Application Priority Data
Oct. 13, 2022 (DE) 10 2022 126 757.1

(51) Int. Cl. C03C 25/255; D04H 1/4218; D04H 1/46

(52) U.S. Cl. CPC C03C 25/255; D04H 1/4218; D04H 1/46

(57) ABSTRACT

A needle felt includes mineral wool and a fatty acid amide amine. A fatty acid amide amine is used in the production of a needle felt from a mineral wool.

### TECHNICAL FIELD

The present invention relates to needle felts (needle fleeces or needle fleece) made of mineral wool, in particular of glass wool or rock wool, which can be used for the thermal insulation of furnaces, in particular of industrial or domestic furnaces. More specifically, the present invention relates to a needle felt comprising mineral wool and a fatty acid amide amine or a fatty acid amine amide according to claim 1, and to a use of a fatty acid amide amine or a fatty acid amine amide in the production of a needle felt from a mineral wool according to claim 10.

### STATE OF THE ART

The production of needle felt is well known to the skilled person and is described, for example, in document DE 389 35 007 A1 and EP 0 363 707 A2. Additives for the production of needle felts, also known as avivage agents, are used in the prior art to improve the manufacturing process and the properties of the resulting needle felts. For example, in addition to perfluorinated polyether/polyfluoropolyether compounds (PFPE; e.g. representatives of the Fomblin product family), mineral oil-based lubricants are also used. More recent, improved developments provide for the use of additives consisting of polymers based on azacyclopropane (ethylene imine). For example, aqueous solutions or dispersions of halogen-free, cationic homopolymers based on azacyclopropane or of copolymers based on ethane-1,2-diamine and azacyclopropane, or mixtures thereof, are proposed as suitable avivage agents in document EP 3 208 246 A.

The advantage of this class of additives is that needle felts treated with them do not release hydrogen fluoride HF and formaldehyde only in quantities that are not harmful to health, even in the case of high thermal stress, for example at temperatures of around 350 °C or even 500 °C. Therefore, such avivage agents are excellently suited for insulating materials, which are used, for example, for thermal insulation of industrial or household furnaces with pyrolysis function.

However, the use of this class of avivage agents in practice has shown that, despite their excellent suitability for the use of insulating materials made with them for the thermal insulation of industrial or domestic furnaces, they cause hitherto unknown problems during the manufacturing process or during storage of the needle felts prior to the final application.

In detail, the inventors of the present application have found that the use of additives consisting of polymers based on azacyclopropane (ethylene imine) causes problems, especially during the manufacture and storage of needle felts produced using the above-mentioned avivage agents. On the one hand, the needle felts produced in this way contain a greater amount of water due to the manufacturing process. This makes the drying of the needle felts more costly in terms of energy and process technology, and the energy required for drying increases. On the other hand, the residual moisture present in the needle felt is unevenly distributed and leads to post-curing or post-hardening and, presumably as a result, to sticking of the needle felt mats during intermediate storage before they are finally installed as insulating materials. In concrete terms, problems have arisen in such cases when separating needle felt mats or shaped pieces stored in stacks because of sticking. In addition, it was observed in the practical application of conventional needle felt additives that the conventionally produced needle felt was sometimes very stiff, which is why the manual or mechanical force required to bring it into the desired shape was very high and often resulted in the needle felt breaking during forming.

Other needling additives are also known to the skilled person from the prior art, but they are based on fundamentally different material approaches. For example, the documents WO 2018/050 924 A1 and EP 3 260 589 B1 each propose needling additives based on or consisting of graphite.

Patent publications DE 601 21 333 T2 and DE 601 22 889 T2 relate to mineral wool-based thermal or acoustic insulating materials, the surface of which is at least partially coated with a softening composition. The surface coating aims to improve the feel of the insulation bodies, so that the products are more pleasant to touch and are perceived as softer. Moreover, the coatings may also improve the mechanical properties of the insulating materials, in particular, improve the stiffness of the outermost layer. The softening composition comprises at least one surfactant, preferably a cationic surfactant having a net positive charge (e.g., an amidoamine salt) or a delocalized charge (e.g., an amine oxide). Fatty acid derivatives having one or more nitrogen groups capable of carrying a positive delocalized or net charge to bind the molecule to the fiber are suitable. These include, for example, tertiary amines or quaternary ammonium salts or amine oxides. Quaternary ammonium or imidazolinium salts with hydrocarbon chains with, for example, a counterion of the acetate type or amine oxides with fatty chains with a dative bond between oxygen and nitrogen are disclosed as being particularly suitable. Alternatively, the publications disclose the use of non-ionic surfactants or plasticizers, in particular fatty acid esters. However, none of these documents disclose the application of a neutral fatty acid amide amine in the manufacturing of a mineral wool-based needle felt material.

### OBJECT OF THE INVENTION

The object of the present invention is therefore to provide an improved needle felt which at least partially overcomes the disadvantages of the prior art discussed above.

Accordingly, it is also an object of the present invention to provide the use of an advantageous needling additive in the manufacture of needle felts.

### SUMMARY OF THE INVENTION

The above-mentioned object is solved by the subject-matter of the independent claims. Advantageous embodiments of the present invention are the subject-matter of the dependent claims.

Thus, according to the invention, a needle felt is proposed which contains at least a mineral wool and a fatty acid amide amine. The needle felt can be produced by needling the mineral wool using the fatty acid amide amine or is produced by needling the mineral wool using the fatty acid amide amine. Thereby, the needle felt preferably contains neither formaldehyde nor fluorine, and thus, can be produced without an addition of formaldehyde or a fluorine-containing substance. The needle felt according to the invention may also be limited in that the needle felt consists of the mineral wool and the fatty acid amide amine and does not contain any other components. Excluded from this may be a residual moisture content of the needle felt which may occur during storage (water content up to 0.2 mass percent, preferably up to 0.1 mass percent, determined gravimetrically).

The inventors of the present invention have found that by using a fatty acid amide amine in the production of needle felt from mineral wool, it is possible to obtain a needle felt which, on the one hand, meets the requirements regarding low formaldehyde and acetaldehyde emission under thermal stress: Thus, an emission of formaldehyde of <17 mg/kg was found in all samples, while an emission of acetaldehyde was not detectable (measured according to the method of the accredited testing laboratory TÜV Rheinland LGA Products GmbH=tube furnace method at T_{tube furnace}=350 °C over t=60 min, following DIN ISO 16000-3, at the furnace having a pyrolysis function with needle felt with thickness of 30 mm and volume weight of 60 kg/m³; each triple determination; coefficient of variation: <2.5%, “LGA method”). Thus, the needle felt according to the invention meets the practice requirements of the producing industry for the above-described application as an insulating material for industrial and domestic furnaces.

In addition, the inventors have surprisingly found that the needle felt according to the invention is easier to process due to its lower product stiffness compared to conventional products. Furthermore, it was surprisingly found that mats or molded parts made of the needle felt according to the invention do not stick together during an intermediate storage until their final use, for example as insulating material in a household furnace or household oven. Thus, even after several weeks of storage in stacks, these molded parts can be separated again without any problems and without any particular effort or damage to the molded parts. With the needling additives conventionally used, on the other hand, problems regularly occurred when separating needle-felt molded parts stored in stacks.

The manufacturing process of the needle felt according to the invention is identical to conventional manufacturing processes, with the exception that a different needling additive, namely a fatty acid amide amine, is provided or used according to the invention. The skilled person is familiar with manufacturing processes for needling additives and needle felts, for example, from paragraphs [0043, 0044; 0048; 0049; 0052; 0060 to 0064] of document EP 3 208 246 A1. In principle, the needle felt according to the invention can be produced by conventional application/spraying of a needling additive solution when separating the needles, whereby the needling additive solution can be produced by providing water, acidifying the water with an acid and then adding the fatty acid amide amine and homogenizing the mixture. The acid here has an emulsifying function for the needling additive in the water. Here, the concentration of the needling additive in the needling additive solution is typically 0.1 to 0.2 mass percent. Example of preparation of a needling additive solution: providing of 250 kg of water (35 °C), addition of 70 g of 25% H₂SO₄ (to adjust a pH of 3 to 4), homogenization, addition of 250 g of fatty acid amide amine, and subsequent homogenization of the resulting mixture yields a 0.1% needling additive solution.

In principle, all acids can be used to acidify the water, although inorganic acids are preferred because of the lack of organic components. Acids with organic components can decompose under the exposure of heat to formaldehyde and/or acetaldehyde, which is problematic due to the emission problem in the use of the needle felt provided according to the invention. Therefore, in the context of the present invention, the use of sulfuric acid, phosphoric acid and amidosulfonic acid are particularly preferred in the preparation of the needling additive solution. Hydrochloric acid can also be used, provided that corrosion does not occur on the equipment parts of the production plant or during subsequent product use.

According to the invention, the term mineral wool includes rock wool, glass wool and any mixture thereof.

Furthermore, the fatty acid part of the fatty acid amide amine may be a C4 to C22 fatty acid, preferably a C16 to C20 fatty acid, particularly a C18 fatty acid.

Further, the fatty acid part may be or be based on an unbranched carbon chain.

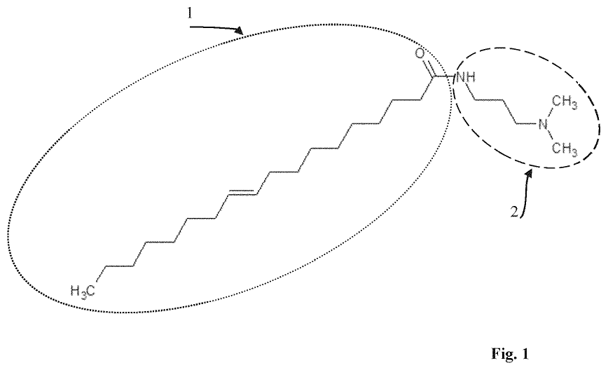

In the context of the present application, the term “fatty acid part” means the aliphatic carbon chain up to and including the C═O group, but excluding the N atom of the amide bond of the fatty acid amide amine. The fatty acid part of the fatty acid amide amine provided in accordance with the invention is indicated by the reference sign “1” in the fatty acid amide amine reproduced by way of example in FIG. 1.

If the chain length of the fatty acid part (1) is more than 22 carbon atoms (>C22), then there is a risk of undesirably high emission of formaldehyde and other volatile organic pollutants. If the chain length of the fatty acid part (1) is less than 4 carbon atoms (<C4), then there is a concern that the lubricating effect of the needling additive during the needle felt manufacturing process is too low. Thus, selecting the chain length of the fatty acid part (1) from a range between C4 and C22 realizes a good lubricating effect of the needling additive without risking excessive emission of volatile organic pollutants. A chain length of the fatty acid part from C16 to C20, in particular from C16 to C18, has been found to be optimal.

According to the invention, the fatty acid part (1) of the fatty acid amide amine may be or be based on a saturated, a mono-, double- or triple-unsaturated fatty acid. According to the invention, “mono-unsaturated” means the presence of a C—C double bond in the carbon chain. Analogously, “double-unsaturated” means the presence of two C—C double bonds in the carbon chain. Analogously, “triple-unsaturated” means the presence of three C—C double bonds in the carbon chain. For example, the presence of one or more double bonds in the carbon chain of the fatty acid moiety has an effect on the state of aggregation of the needling additive. Thus, a needling additive of the invention with a saturated C18 fatty acid moiety may be a solid, while a mono-unsaturated C18 moiety with a double bond at the C9 position and an otherwise identical molecule is a liquid.

In the context of the present application, the term “amine part” means that part of the fatty acid amide amine up to and including the N atom of the amide bond of the fatty acid amide amine which does not belong to the fatty acid part as defined above. The amine part of the fatty acid amide amine provided according to the present invention is indicated by the reference sign “2” in the fatty acid amide amine reproduced by way of example in FIG. 1.

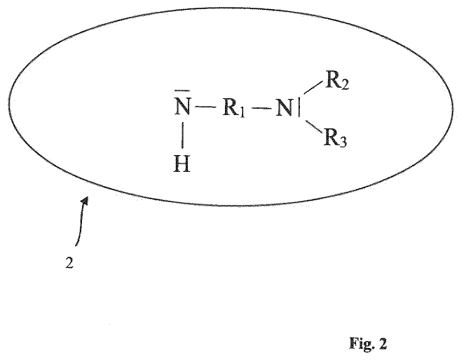

According to the invention, the amine part (2) of the fatty acid amide amine may have the following structural formula: NHR₁NR₂R₃ (corresponding to the structure reproduced in FIG. 2). Therein, R₁ is selected independently of R₂ and R₃ from a group consisting of: CH₂, C₂H₄, C₃H₆ and C₄H₈. Therein, R₂ is selected independently of R₁ and R₃ from a group consisting of: CH₃, C₂H₅ and C₃H₇. Further, R₃ is selected independently of R₁ and R₂ from a group consisting of: CH₃, C₂H₅ and C₃H₇.

In particularly preferred embodiments of the present invention, the amine part (2) is 3-aminopropyldimethylamine, 2-aminoethyldimethylamine, or 2-aminoethyldiethylamine or based on any of these.

For the amine part (2), methyl groups are preferred over ethyl or even larger alkyl groups for the groups R₂ and R₃, since formaldehyde release is reduced upon exposure to heat. For the same reason, the carbon chain of the alkyl group R₁ should not exceed a chain length of C4. In principle, the following applies to the groups R₁, R₂ and R₃ of the amine part (2): the fewer C atoms the respective group has, the less formaldehyde is generated and released under thermal stress.

In a preferred embodiment of the needle felt according to the invention, the fatty acid part (1) of the fatty acid amide amine can be a C4 to C22 fatty acid, preferably a C16 to C20 fatty acid, in particular a C18 fatty acid, with a saturated, mono-, double- or triple-unsaturated carbon chain, and the amine part (2) of the fatty acid amide amine may be a trialkylamine, preferably an aminotrialkylamine, in particular 3-aminopropyldimethylamine, 2-aminoethyldimethylamine or 2-aminoethyldiethylamine, or may be based on one of these.

In a further preferred embodiment of the needle felt according to the invention, the fatty acid part (1) of the fatty acid amide amine may be a C16 to C20 fatty acid, in particular a C18 fatty acid, having a saturated, mono-, double- or triple-unsaturated carbon chain, and the amine part of the fatty acid amide amine may be 3-aminopropyldialkyl-amine, 2-aminoethyldimethylamine or 2-aminoethyldiethylamine, or based on any of these.

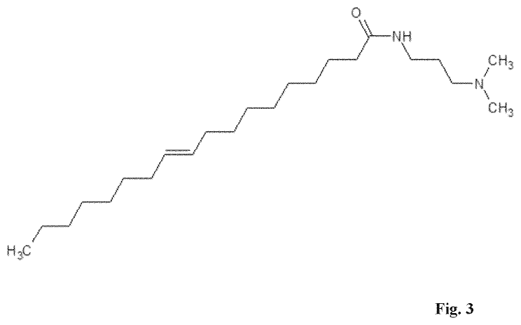

In a particularly preferred embodiment of the needle felt according to the invention, the fatty acid amide amine is (9E)-N-[3-(dimethylamino)propyl]octadec-9-enamide (CAS No. 1379524-06-7) (cf. structural formula in FIG. 3). This fatty acid amide amine is commercially available, for example, under the name “Evonik Tego Addibit L 300 N”, distributed by Evoniks Operations GmbH, 45128 Essen/Germany.

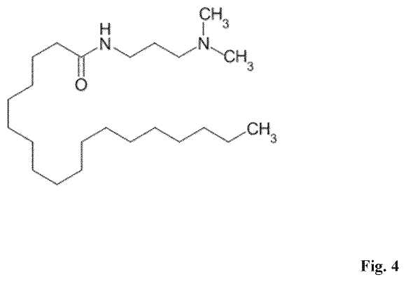

In a further, particularly preferred embodiment of the needle felt according to the invention, the fatty acid amide amine is N-[3-(dimethylamino)propyl]stearamide (CAS No. 7651-02-7) (cf. structural formula in FIG. 4). This fatty acid amide amine is commercially available, for example, under the name “Evonik Tego Addibit F4 HB”, distributed by Evoniks Operations GmbH, 45128 Essen/Germany, or under product number S360864 from Sigma-Aldrich Chemie GmbH, 82024 Taufkirchen/Germany.

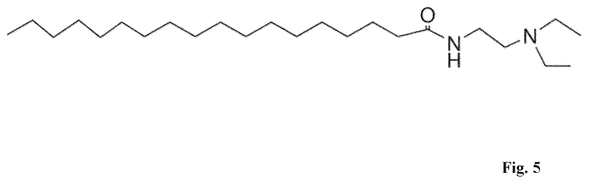

In a further, particularly preferred embodiment of the needle felt according to the invention, the fatty acid amide amine is N-(2-(diethylamino)ethyl]stearamide (CAS No. 16889-14-8) (cf. structural formula in FIG. 5). This fatty acid amide amine is commercially available, for example, under product number S678910 from Sigma-Aldrich Chemie GmbH, 82024 Taufkirchen/Germany.

According to the invention, the last three fatty acid amide amines mentioned can also be used in any mixing ratio in the form of a solution mixture as needling additives, so that the resulting needle felt according to the invention also contains two or three fatty acid amide amines in addition to mineral wool. The fatty acid amide amine (9E)-N-[3-(dimethylamino)propyl]octadec-9-enamide can be used in a wider range of concentrations or proportions compared to the N-[3-(dimethylamino)propyl]stearamide, which is advantageous because it facilitates the handling of the fatty acid amide amine.

The needle felt according to the invention can be characterized by the fact that it does not contain silicone, in particular silicone oil. Additionally or alternatively, the needle felt according to the invention may be free of graphite. Additionally or alternatively, the needle felt according to the invention may be free of a polymer based on azacyclopropane (=aziridine=ethylene imine). In the context of the present invention, “contains no . . . ”, “does not contain” or “is free from . . . ” or similar formulations means a mass fraction of the substance in question of <1,000 ppm, preferably <100 ppm, in particular <10 ppm, based on the total mass of the needle felt. The absence of the above-mentioned substances conventionally used as needling additives means that their adverse effects can be avoided.

Furthermore, in the needle felt according to the invention, the mass fraction of the fatty acid amide amine can be 0.010 to 0.050%, preferably 0.010 to 0.030%, in particular 0.015 to 0.030%, based on the total mass of the needle felt. By selecting the mass fraction of the fatty acid amide amine in the above-mentioned ranges, on the one hand a sufficient lubricating effect of the needling additive is ensured and a breaking of the mineral wool fibers during the production of the needle felt is avoided. Moreover, at mass fractions of <0.010%, delamination of the needle felt produced may occur, as observed by the inventors. On the other hand, a sufficiently low stiffness of the resulting needle felt is achieved in the proposed proportion ranges, while at the same time using only a small amount of additive. Thus, the use of the fatty acid amide amine according to the invention requires only about 25% of the needling additive quantity that had to be used by the conventional needling additives discussed above, resulting in a considerable material saving with respect to the needling additive according to the invention. Depending on the mineral wool used, the needling additive provided according to the invention results in stiffnesses of the finished needle felt that are undesirably high for further processing from a mass fraction of the fatty acid amide amine of >0.030% and in particular from >0.050%. In addition, the needle felt tends to break during further processing from a mass fraction of the fatty acid amide amine of >0.050%.

Furthermore, by restricting the needle felt to the above mass fraction ranges, compliance with the emission of formaldehyde and acetaldehyde in particular can be maintained when the needle felt according to the invention is used as an insulating material for an industrial or domestic furnace, even in the presence of a pyrolysis function. It is particularly important that when the upper limit of 0.050% or better 0.030% is met, the stiffness of the resulting needle felt is still low enough that the needle felt can be processed without problems, i.e. that it is neither too stiff to be bent into the desired shape nor that it breaks during forming.

The object of the present invention is further solved by the use according to claim 9. Thus, according to the invention, the use of a fatty acid amide amine in the production of a needle felt from a mineral wool, preferably as a needling additive, is proposed. The use according to the invention advantageously causes a reduction of the residual moisture and/or of the tendency to sticking of the needle felt, namely during the intermediate storage of the insulating material prior to the subsequent, intended use of the needle felt, for example as insulating material in an industrial or household furnace.

In the context of the use according to the invention, the optional features and limitations and advantages disclosed above for the needle felt according to the invention and the fatty acid amide amine also apply analogously to its use according to the invention.

### EXAMPLES

Processable needling additive solutions with an additive mass concentration of 0.1% were prepared as follows:
providing 250 kg of water (35 °C),
addition of 100 g of 70% methanesulfonic acid or of 70 g of 25% H₂SO₄,
homogenization,
addition of 250 g of the needling additive, and
subsequent homogenization of the resulting mixture.

The needling additive used was ((9E)-N-[3-(dimethylamino)propyl]octadec-9-enamide, in this case the product EVONIK TEGO Addibit L300N, hereafter abbreviated as “L 300 N” or N-[3-(dimethylamino)propyl]stearamide, in this case the product EVONIK TEGO Addibit F4 HB, hereafter abbreviated as “F4 HB”.

The glass wool fibers produced from a melt in an internal centrifugation process, which is also referred to as the TEL process, were sprayed in the drop chute according to standard procedures, deposited on a collecting belt and transported to a needling device. According to the specifications of the LGA method, the glass wool needle felt had a bulk density of 60 kg/m³, a thickness of 30 mm with different contents of needling additive.

The samples were analyzed according to the LGA method cited above (tube furnace method at T_{tube furnace}=350 °C for t=60 min, following DIN ISO 16000-3, furnace with pyrolysis function; triplicate determination each; coefficient of variation: <2.5%).

In a first series of tests, needling additives with the addition of methanesulfonic acid were produced and tested. The results are summarized in Tables 1 and 2 below.

TABLE 1
Measured values of the formaldehyde release of the needle
felt according to the invention (with methanesulfonic acid)

| | | mass fraction of the | |
|---|---|---|---|
| | | needle additive | |
| | | relative to the | measured value |
| Sample | needling | needle felt | formaldehyde |
| number | additive | [%] | [mg/L] |
| 1 | L 300N* | 0.010 | 9.32 |
| 2 | L 300N* | 0.020 | 13.31 |
| 3 | L 300N* | 0.030 | 15.26 |
| 4 | F4 HB** | 0.010 | 9.85 |
| 5 | F4 HB** | 0.020 | 13.08 |
| 6 | F4 HB** | 0.030 | 16.62 |

*= (9E)-N-[3-(dimethylamino)propyl]octadec-9-enamide
**= N-[3-(dimethylamino)propyl]stearamide

TABLE 2
Measured values of the acetaldehyde release
of the needle felt according to the invention

| | | mass fraction of the | |
|---|---|---|---|
| | | needle additive | |
| | | relative to the | measured value |
| Sample | needling | needle felt | acetaldehyde |
| number | additive | [%] | [mg/L] |
| 1 | L 300N* | 0.010 | n.d.*** |
| 2 | L 300N* | 0.020 | n.d.*** |
| 3 | L 300N* | 0.030 | n.d.*** |
| 4 | F4 HB** | 0.010 | n.d.*** |
| 5 | F4 HB** | 0.020 | n.d.*** |
| 6 | F4 HB** | 0.030 | n.d.*** |

*= (9E)-N-[3-(dimethylamino)propyl]octadec-9-enamide
**= N-[3-(dimethylamino)propyl]stearamide
***= not detectable

As shown in Tables 1 and 2, an emission of formaldehyde of <17 mg/kg was measured in all tested samples of the needle felt according to the invention under realistic conditions of use (350 °C, 60 min), while an emission of acetaldehyde was not detectable. Thus, the needle felts according to the invention examined here meet the practical requirements of the industry for the application described above as an insulating material for industrial and domestic furnaces.

Methanesulfonic acid was selected because of its low boiling point of approx. 170 °C and good handling properties. According to chemical literature, methanesulfonic acid should also decompose thermally without forming formaldehyde or acetaldehydes.

In another series of tests, needling additives were prepared and tested with the addition of an inorganic acid, in this case sulfuric acid, according to the above data (only with L 300 N); also for comparison with methanesulfonic acid. The results are summarized in Table 3 below.

TABLE 3
Measured values of the formaldehyde release of the needle
felt according to the invention (with sulfuric acid)

| | | mass fraction of the | |
|---|---|---|---|
| | | needle additive | |
| | | relative to the | measured value |
| Sample | needling | needle felt | formaldehyde |
| number | additive | [%] | [mg/L] |
| 1 | L 300N* | 0.010 | 8.30 |
| 2 | L 300N* | 0.015 | 9.93 |
| 3 | L 300N* | 0.020 | 10.28 |

*= (9E)-N-[3-(dimethylamino)propyl]octadec-9-enamide

As shown in Table 3, the needle felts of the test series according to the invention with an inorganic acid also meet the practical requirements of the industry for the above-described application as insulating material for industrial and domestic furnaces.

Surprisingly, an unexpected improvement, i.e., reduction of formaldehyde emissions by about 10% at a mass fraction of 0.01% and by about 30% at a mass fraction of 0.02% compared to the values with a needling avivage agent with methanesulfonic acid is shown.

In addition, after several weeks of storage in unheated rooms in stacked form, all sample molded parts could be separated without any problems and without sticking to each other.

During further processing, which included a step of manually bending the needle felt mats of the invention around a furnace prototype, the needlefelt mats were sufficiently flexible and showed no breaks in the material.

TABLE 4
Moisture contents of the needle felt according to the invention,
determined gravimetrically in triplicate; standard deviation
in each case ≤0.02% (with methanesulfonic acid)

| | | mass fraction of the | |
|---|---|---|---|
| | | needle additive | |
| | | relative to the | mass fraction |
| Sample | needling | needle felt | of moisture |
| number | additive | [%] | [%] |
| 1 | L 300N* | 0.010 | 0.06 |
| 2 | L 300N* | 0.020 | 0.08 |
| 3 | L 300N* | 0.030 | 0.04 |
| 4 | F4 HB** | 0.010 | 0.03 |
| 5 | F4 HB** | 0.020 | 0.02 |
| 6 | F4 HB** | 0.030 | 0.02 |

*= (9E)-N-[3-(dimethylamino)propyl]octadec-9-enamide
**= N-[3-(dimethylamino)propyl]stearamide

Comparative tests with the test samples based on sulfuric acid showed no influence of the acid on the moisture.

In addition, the moisture content and thus, the residual moisture of the needle felts according to the invention were extremely low at <0.10%, so that subsequent drying of the needle felts according to the invention was no longer necessary, even after longer intermediate storage, and a further process step could thus be saved in addition to the additional energy required for subsequent drying.

1. Needle felt, containing a mineral wool and a fatty acid amide amine;
wherein the needle felt comprises needled mineral wool using the fatty acid amide amine.

2. The needle felt according to claim 1, wherein the mineral wool is rock wool or glass wool.

3. The needle felt according to claim 1, wherein the fatty acid part of the fatty acid amide amine is or is based on a C4 to C22 fatty acid.

4. The needle felt according to claim 1, wherein the fatty acid part of the fatty acid amide amine has an unbranched carbon chain.

5. The needle felt according to claim 1, wherein the fatty acid part of the fatty acid amide amine is or is based on a mono-, double- or triple-unsaturated fatty acid.

6. The needle felt according to claim 1, wherein the amine part of the fatty acid amide amine has the structural formula: NHR₁NR₂R₃; wherein R₁ is selected independently of R₂ and R₃ from a group consisting of: CH₂, C₂H₄, C₃H₆ and C₄H₈; wherein R₂ is selected independently of R₁ and R₃ from a group consisting of: CH₃, C₂H₅ and C₃H₇; and wherein R₃ is selected independently of R₁ and R₂ from a group consisting of: CH₃, C₂H₅ and C₃H₇; and wherein the amine part is 3-aminopropyldimethylamine, 2-aminoethyldimethylamine or 2-aminoethyldiethylamine, or is based on one of 3-aminopropyldimethylamine, 2-aminoethyldimethylamine or 2-aminoethyldiethylamine.

7. The needle felt according to claim 1, wherein the fatty acid amide amine is (9E)-N-[3-(dimethylamino)propyl]octadec-9-enamide having CAS no. 1379524-06-7, N-[3-(dimethylamino)propyl]stearamide having CAS No. 7651-02-7, N-(2-(diethylamino)ethyl]stearamide having CAS No. 16889-14-8, or any mixture thereof.

8. The needle felt according to claim 1, wherein the needle felt contains no silicone, no silicone oil, and/or no graphite and/or no polymer based on an azacyclopropane, wherein the needle felt contains no silicone, no graphite and no polymer based on an azacyclopropane.

9. The needle felt according to claim 1, wherein the mass fraction of the fatty acid amide amine to the total mass of the needle felt is 0.010 to 0.050%.

10. A method of producing a needle felt from a mineral wool, comprising adding a fatty acid amide amine as a needling additive, for reducing residual moisture and/or tendency of the needle felt to stick together.

11. The method according to claim 10, wherein the fatty acid part of the fatty acid amide amine is or is based on a C4 to C22 fatty acid.

12. The method according to claim 10, wherein the fatty acid part (H) of the fatty acid amide amine has an unbranched carbon chain.

13. The method according to claim 10, wherein the fatty acid part (H) of the fatty acid amide amine is or is based on a mono-, double- or triple-unsaturated fatty acid.

14. The method according to claim 10, wherein the amine part of the fatty acid amide amine has the structural formula: NHR₁NR₂R₃; wherein R₁ is selected independently of R₂ and R₃ from a group consisting of CH₂, C₂H₄, C₃H₆ and C₄H₈; wherein R₂ is selected independently of R₁ and R₃ from a group consisting of: CH₃, C₂H₅ and C₃H₇; and wherein R₃ is selected independently of R₁ and R₂ from a group consisting of: CH₃, C₂H₅ and C₃H₇; and wherein the amine part is 3-aminopropyldimethylamine, 2-aminoethyldimethylamine or 2-aminoethyldiethylamine, or is based on one of aminopropyldimethylamine, 2-aminoethyldimethylamine or 2-aminoethyldiethylamine.

15. The method according to claim 10, wherein the fatty acid amide amine is (9E)-N-[3-(dimethylamino)propyl]octadec-9-enamide having CAS no. 1379524-06-7, N-[3-(dimethylamino)propyl]stearamide having CAS No. 7651-02-7, N-(2-(diethylamino)ethyl]stearamide having CAS No. 16889-14-8, or any mixture thereof.

16. The method according to claim 10, wherein the needle felt contains no silicone, no silicone oil, and/or no graphite and/or no azacyclopropane-based polymer, wherein the needle felt contains no silicone, no graphite and no azacyclopropane-based polymer.

17. The method according to claim 10, wherein the mass fraction of the fatty acid amide amine to the total mass of the needle felt is 0.010 to 0.050%.
